(19) United States
(12) Patent Application Publication
(10) Pub. No.: US 2011/0316892 A1
(43) Pub. Date: Dec. 29, 2011

(54) ORGANIC LIGHT EMITTING DISPLAY AND DRIVING METHOD THEREOF

(76) Inventors: Si-Duk Sung, Yongin-city (KR); Baek-Woon Lee, Yongin-city (KR); In-Hwan Ji, Yongin-city (KR); Sang-Myeon Han, Yongin-city (KR)

(21) Appl. No.: 13/076,282

(22) Filed: Mar. 30, 2011

(30) Foreign Application Priority Data
Jun. 28, 2010 (KR) 10-2010-0061395

(51) Int. Cl. G09G 3/32; G09G 5/10; G09G 5/00

(52) U.S. Cl. 345/690; 345/212; 345/76

(57) ABSTRACT

An organic light emitting diode display includes: a display unit including: a plurality of scan lines; a plurality of light emission control lines; a plurality of data lines; and a plurality of pixels, each of the pixels being coupled to a corresponding scan line among the scan lines, a corresponding light emission control line among the light emission control lines, and a corresponding data line among the data lines; a scan driver configured to transmit a plurality of scan signals to the scan lines; a light emission driver configured to transmit a plurality of light emission control signals to the light emission control lines; a data driver configured to transmit a plurality of data signals to the data lines; and a power source driver configured to apply a plurality of power source voltages having different levels to the pixels during one frame period.

### CROSS-REFERENCE TO RELATED APPLICATION

This application claims priority to and the benefit of Korean Patent Application No. 10-2010-0061395 filed in the Korean Intellectual Property Office on Jun. 28, 2010, the entire content of which is incorporated herein by reference.

### BACKGROUND

1. Field

Embodiments of the present invention relate to an organic light emitting diode (OLED) display and a driving method thereof.

2. Description of the Related Art

Various kinds of flat display devices that are capable of reducing detriments of cathode ray tubes (CRT), such as their heavy weight and large size, have been developed in recent years. Such flat display devices include liquid crystal displays (LCDs), field emission displays (FEDs), plasma display panels (PDPs), and organic light emitting diode (OLED) displays.

Among the above flat panel displays, the OLED display using an organic light emitting diode (OLED) generating light by a recombination of electrons and holes for the display of images has a fast response speed, is driven with low power consumption, and has excellent luminous efficiency, luminance, and viewing angle and therefore it has been spotlighted.

Generally, the organic light emitting diode (OLED) display is classified into a passive matrix OLED (PMOLED) or an active matrix OLED (AMOLED) according to a driving method of the organic light emitting diode (OLED).

Among them, in aspects of resolution, contrast, and operation speed, the current trend is toward the AMOLED display where respective unit pixels selectively turn on or off.

One pixel of the AMOLED includes the OLED, a driving transistor controlling a current amount supplied to the OLED, and a switching transistor transmitting a data signal to the driving transistor for controlling an amount of light emitted by the OLED.

A driving method of an AMOLED may include a reset period for resetting an anode voltage of the OLED and a light emitting period for emitting light in accordance with a current corresponding to an entire OLED.

According to this driving method, a leakage current flows through the switching transistor during the reset period and light is emitted. Thus, the image quality of the display device may be deteriorated.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provides an organic light emitting diode (OLED) display capable of reducing or minimizing an unnecessary leakage current and concurrently or simultaneously actively executing a driving operation by controlling for each period according to a driving method of each pixel of an organic light emitting diode (OLED) display, and a driving method thereof.

Embodiments of the present invention are not limited to the above-mentioned embodiments, and therefore other embodiments can be clearly understood by those skilled in the art to which embodiments of the present invention pertains from the following description.

According to one embodiment of the present invention, an organic light emitting diode (OLED) display includes: a display unit including: a plurality of scan lines; a plurality of light emission control lines; a plurality of data lines; and a plurality of pixels, each of the plurality of pixels being coupled to a corresponding scan line among the plurality of scan lines, a corresponding light emission control line among the plurality of light emission control lines, and a corresponding data line among the plurality of data lines; a scan driver configured to transmit a plurality of scan signals to the plurality of scan lines; a light emission driver configured to transmit a plurality of light emission control signals to the plurality of light emission control lines; a data driver configured to transmit a plurality of data signals to the plurality of data lines; and a power source driver configured to apply a plurality of power source voltages having different levels to the plurality of pixels during one frame period, wherein each of the plurality of pixels includes an OLED and a driving transistor configured to transmit a current to the OLED in accordance with a corresponding data signal of the data signals, and wherein during a reset period a plurality of voltages of the plurality of data signals for resetting a driving voltage of the OLED has a higher voltage than corresponding voltages of the plurality of data signals during a threshold voltage compensation period for compensating for the threshold voltage of the driving transistor.

During the reset period each of the plurality of data signals may have a voltage higher than a highest voltage of a voltage range of the plurality of data signals during a scan period.

During the threshold voltage compensation period each of the plurality of data signals may have a voltage signal equal to a lowest voltage sufficient to turn on the driving transistor.

Each of the plurality of pixels may further include a first switch configured to transmit the corresponding data signal among the plurality of data signals to the driving transistor in accordance with a corresponding scan signal among the plurality of scan signals, and the scan driver may be configured to concurrently transmit the plurality of scan signals to the plurality of scan lines during the reset period and the threshold voltage compensation period.

Each of the plurality of pixels may further include a second switch configured to transmit a first power source voltage to the driving transistor in accordance with a light emission control signal of the light emission control signals. The driving transistor may be coupled to an anode of the organic light emitting diode (OLED). The second switch may be configured to be turned on during the reset period. During the reset period the first power source voltage may be lower than the voltage of a cathode of the OLED.

The scan driver may be configured to sequentially transmit the plurality of scan signals to the plurality of scan lines during a scan period after the reset period and the threshold voltage compensation period, and the data driver may be configured to transmit the plurality of data signals to the plurality of data lines in synchronization with the transmission of the plurality of scan signals to the scan lines.

During a light emitting period, the data driver may be configured to transmit the plurality of data signals to corresponding ones of the plurality of pixels such that substantially no leakage current is generated in a first switch of each pixel configured to transmit the corresponding data signal to the driving transistor.

The first switch may be configured to transmit the corresponding data signal to the driving transistor in accordance with a corresponding scan signal of the plurality of scan signals, and the scan driver may be configured to concurrently transmit the plurality of scan signals to the plurality of scan lines during the light emitting period.

During the light emitting period each of the data signals may have a voltage higher than a highest voltage of a voltage range of the data signal during a scan period.

The scan driver is configured to sequentially transmit the plurality of scan signals to the plurality of scan lines during a scan period before the light emitting period and after the reset period and the threshold voltage compensation period, and

The data driver may be configured to transmit the plurality of data signals to the plurality of data lines in synchronization with the transmission of the plurality of scan signals to the scan lines.

According to one embodiment of the present invention, an organic light emitting diode (OLED) display includes: a display unit including: a plurality of scan lines; a plurality of light emission control lines; a plurality of data lines; and a plurality of pixels, each of the plurality of pixels being coupled to a corresponding scan line among the plurality of scan lines, a corresponding light emission control line among the plurality of light emission control lines, and a corresponding data line among the plurality of data lines; a scan driver configured to transmit a plurality of scan signals to the plurality of scan lines; a light emission driver configured to transmit a plurality of light emission control signals to the plurality of light emission control lines; a data driver configured to transmit a plurality of data signals to the plurality of data lines; and a power source driver configured to apply a plurality of power source voltages having different levels to the plurality of pixels during one frame period, wherein each of the plurality of pixels includes an OLED, a driving transistor configured to transmit a current to the OLED in accordance with a corresponding data signal of the data signals and a first switch configured to transmit the corresponding data signal to the driving transistor, and wherein the data driver is configured to supply, during a light emitting period, the plurality of data signals to the plurality of pixels, the plurality of data signals having voltages which generate substantially no leakage current in the first switch.

The first switch may be configured to transmit the corresponding data signal to the driving transistor in accordance with a corresponding scan signal of the plurality of scan signals, and the scan driver may be configured to concurrently transmit the plurality of scan signals to the plurality of scan lines during the light emitting period.

During the light emitting period each of the data signals may have a voltage higher than a highest voltage of a voltage range of the data signals during a scan period such that substantially no leakage current is generated in the first switch.

The scan driver may be configured to sequentially transmit the plurality of scan signals to the plurality of scan lines during a scan period before the light emitting period in which the plurality of scan signals are transmitted to the plurality of scan lines, and the data driver may be configured to transmit the plurality of data signals to the plurality of data lines in synchronization with the transmission of the plurality of scan signals to the scan lines.

According to one embodiment of the present invention, an organic light emitting diode (OLED) display includes: an OLED; a driving transistor configured to transmit a driving current in accordance with a data signal of a plurality of data signals to the OLED; and a first switch configured to transmit the data signal to a gate terminal of the driving transistor in accordance with a scan signal, wherein during a reset period a voltage of the data signal for resetting a driving voltage of the OLED is higher than a voltage of the data signal during a threshold voltage compensation period for compensating for the threshold voltage of the driving transistor.

During the reset period the data signal may have a voltage higher than a highest voltage of a voltage range of the plurality of data signals during a scan period.

During the threshold voltage compensation period the data signal may have a voltage equal to a lowest voltage that is sufficient to turn on the driving transistor.

The OLED display may further include a second switch configured to transmit a first power source voltage to the driving transistor in accordance with a light emission control signal, wherein the driving transistor may be connected to an anode of the OLED, wherein the second switch may be configured to be turned on during the reset period, and wherein the first power source voltage may be configured to be lower than a voltage of a cathode of the OLED during the reset period.

The first switch may be configured to receive the scan signal during a scan period after the reset period and the threshold voltage compensation period, and the gate terminal of the driving transistor may be configured to receive the data signal in synchronization with the scan signal received by the first switch.

During a light emitting period, the data signal may have a voltage such that substantially no leakage current is generated in the first switch.

The voltage such that substantially no leakage current is generated in the first switch may be higher than a highest voltage of a voltage range of the data signal during a scan period.

The first switch may be configured to receive the scan signal during a scan period before the light emitting period and after the reset period and the threshold voltage compensation period, and the gate terminal of the driving transistor may be configured to receive the data signal in synchronization with the scan signal.

According to one embodiment of the present invention, an organic light emitting diode (OLED) display includes: an OLED; a driving transistor configured to transmit a driving current in accordance with a data signal to the OLED; and a first switch configured to transmit the data signal to a gate terminal of the driving transistor in accordance with a scan signal, wherein, during a light emitting period, the data signal has a voltage such that substantially no leakage current is generated in the first switch.

The voltage such that substantially no leakage current is generated in the first switch may be higher than a highest voltage of a voltage range of the data signal during a scan period.

The first switch may be configured to receive the scan signal during a scan period before the light emitting period, and the gate terminal of the driving transistor may be configured to receive the data signal corresponding to the scan signal in synchronization with the scan signal.

According to one embodiment of the present invention, a driving method of an organic light emitting diode (OLED) display including a plurality of pixels, wherein each of the plurality of pixels includes an OLED and a driving transistor configured to transmit a driving current in accordance with a data signal to the OLED, including: resetting a driving voltage of the organic light emitting diode (OLED) during a reset period; compensating for a threshold voltage of the driving transistor during a threshold voltage compensation period; and transmitting the data signal to the driving transistor during a scan period, wherein a voltage of the data signal during the reset period is higher than a voltage of the data signal during the threshold voltage compensation period.

The voltage of the data signal corresponding to the reset period may be higher than a highest voltage of a voltage range of the data signal during the scan period.

The data signal corresponding to the threshold voltage compensation period may have a voltage equal to a lowest voltage that is sufficient to turn on the driving transistor.

Each of the plurality of pixels may further include a first switch configured to transmit the data signal to the driving transistor in accordance with a scan signal, and a scan driver may be configured to transmit the scan signal to the plurality of pixels during the reset period and the threshold voltage compensation period.

Each of the plurality of pixels may further include a second switch configured to transmit a first power source voltage to the driving transistor in accordance with a light emission control signal. The driving transistor may be coupled to an anode of the OLED. The second switch may be turned-on during the reset period. The first power source voltage may have a voltage lower than the voltage of a cathode of the OLED during the reset period.

During the scan period, a plurality of scan signals may be sequentially transmitted to the plurality of pixels, and the data signal may be transmitted in synchronization with the transmission of a corresponding scan signal of the scan signals.

The driving method may further include transmitting the data signal to the plurality of pixels such that each OLED of the plurality of pixels emits light during a light emitting period after the scan period, wherein during the light emitting period, the data signal may have a voltage such that substantially no leakage current is generated in a first switch configured to transmit the data signal to the driving transistor.

The driving method may further include transmitting the data signal to the driving transistor in accordance with the corresponding scan signal of a plurality of scan signals; and concurrently transmitting the plurality of scan signals during the light emitting period.

The voltage such that substantially no leakage current is generated in the first switch may be higher than a highest voltage of a voltage range of the data signal during the scan period.

During the scan period before the light emitting period, a scan signal may be sequentially transmitted to the plurality of pixels, and the data signal corresponding to the scan signal may be transmitted in synchronization with the transmission of the scan signal.

According to one embodiment of the present invention, a driving method of an organic light emitting diode (OLED) display including a plurality of pixels, wherein each of the plurality of pixels includes an organic light emitting diode (OLED), a driving transistor configured to transmit a driving current in accordance with a data signal to the OLED, and a first switch configured to transmit the data signal to the driving transistor in accordance with a scan signal, including: transmitting the data signal to the driving transistor during a scan period; and emitting light from the OLED in accordance with the driving current during a light emitting period, wherein, during the light emitting period, the data signal may have a voltage such that substantially no leakage current is generated in the first switch.

A scan driver may be configured to concurrently transmit the scan signal to the plurality of pixels during the light emitting period.

The voltage such that substantially no leakage current is generated in the first switch may be higher than a highest voltage of a voltage range of the data signal.

During the scan period before the light emitting period, the scan signal may be sequentially transmitted to the plurality of pixels, and the data signal corresponding to the scan signal may be transmitted in synchronization with the transmission of the scan signal.

The driving method may further include resetting the driving voltage of the OLED during a reset period; and compensating for a threshold voltage of the driving transistor during a threshold voltage compensation period before the scan period and the light emitting period, wherein the voltage of the data signal during the reset period and the voltage of the data signal during the light emitting period may be higher than the voltage of the data signal during the threshold voltage compensation period.

The voltage of the data signal during the reset period and the voltage of the data signal during the light emitting period may be higher than a highest voltage of a voltage range of the data signal transmitted to the driving transistor during the scan period.

During the threshold voltage compensation period the data signal may have a voltage equal to a lowest voltage that is sufficient to turn on the driving transistor.

According to one embodiment of the present invention, in an organic light emitting diode (OLED) display, the voltage of the data signal is changed according to the driving period by the driving circuit of the organic light emitting diode (OLED) display such that the variation of the threshold voltage of the driving transistor may be compensated.

Also, as well as the efficiency compensation of the threshold voltage of the transistor, the leakage current toward the switch transistor of the driving circuit may be concurrently (e.g., simultaneously) reduced or minimized such that the deterioration of the image quality according to the leakage current and the serious quality characteristic deterioration may be prevented.

In addition, in the periods realizing one frame, the electrode voltage of the organic light emitting diode (OLED) and the voltage of the input power source are controlled to the data voltage defined by the predetermined level such that the leakage current toward the organic light emitting diode (OLED) is reduced or minimized, and resultantly the image quality characteristic of the organic light emitting diode (OLED) display may be improved.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram of an organic light emitting diode (OLED) display according to an exemplary embodiment of the present invention.

FIG. 2 is a view showing a driving operation of a light emitting type of organic light emitting diode (OLED) display according to an exemplary embodiment of the present invention.

FIG. 3 is a circuit diagram showing a configuration of the pixel shown in FIG. 1 according to an exemplary embodiment of the present invention.

FIG. 4 is a driving timing diagram showing driving waveforms of a pixel of a concurrent (e.g., simultaneous) emission type of organic light emitting diode (OLED) display according to a conventional exemplary embodiment.

FIG. 5 is a driving timing diagram showing driving waveforms of a pixel of a concurrent (e.g., simultaneous) emission type of organic light emitting diode (OLED) display according to an exemplary embodiment of the present invention.

FIGS. 6, 8, 10, 12, and 14 are circuit diagrams showing a method of driving a pixel of an organic light emitting diode (OLED) display during different periods according to an exemplary embodiment of the present invention.

FIGS. 7, 9, 11, 13, and 15 are driving timing diagrams (or driving waveforms) showing a method of driving a pixel of an organic light emitting diode (OLED) display during different periods according to an exemplary embodiment of the present invention.

### DETAILED DESCRIPTION

In the following detailed description, only certain exemplary embodiments of the present invention have been shown and described, simply by way of illustration. The drawings and description are to be regarded as illustrative in nature and not restrictive, and like reference numerals designate like elements throughout the specification.

Throughout this specification and the claims that follow, when it is described that an element is “coupled” or “connected” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

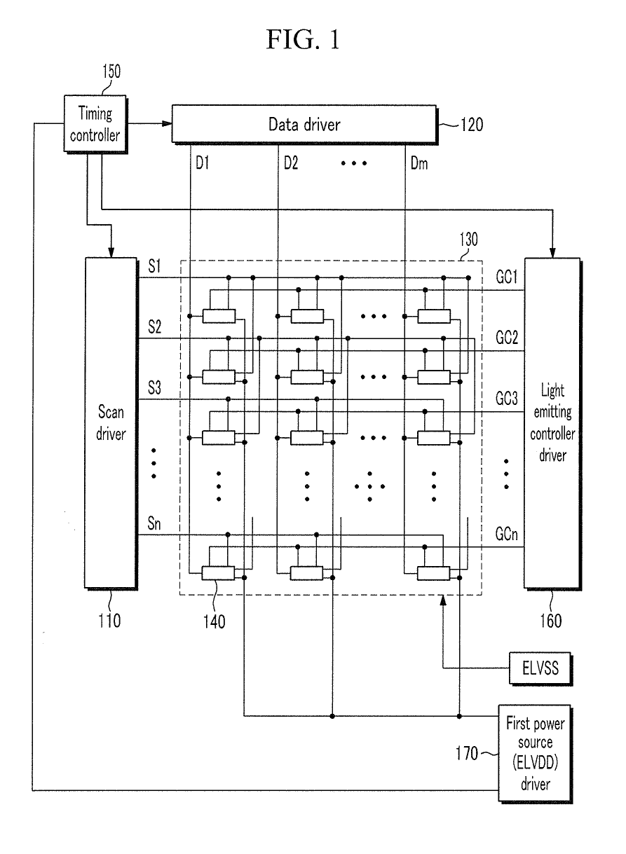

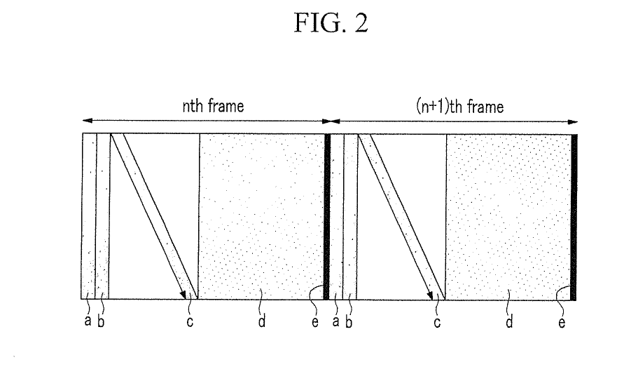

FIG. 1 is a block diagram of an organic light emitting diode (OLED) display according to an exemplary embodiment of the present invention, and FIG. 2 is a view showing a driving operation of an organic light emitting diode (OLED) display according to an exemplary embodiment of the present invention.

Referring to FIG. 1, an organic light emitting diode (OLED) display according to an exemplary embodiment of the present invention includes a display unit 130 including a plurality of pixels 140 connected to a plurality of scan lines S1 to Sn, a plurality of light emission control lines GC1 to GCn, and a plurality of data lines D1 to Dm, a scan driver 110 providing scan signals to each of the pixels 140 through the plurality of scan lines S1 to Sn, a light emission driver 160 providing control signals to each of the pixels through the plurality of light emission control lines GC1 to GCn, a data driver 120 providing data signals to each of the pixels through the plurality of data lines D1 to Dm, and a timing controller 150 controlling the scan driver 110, the data driver 120, and the light emission driver 160.

Also, the display unit 130 includes the pixels 140 which are located at crossing regions of the scan lines S1 to Sn and the data lines D1 to Dm. The pixels 140 receive a voltage from a first power source ELVDD and a second power source ELVSS from the outside.

The pixels 140 supply currents corresponding to organic light emitting diodes (OLEDs) in accordance with corresponding data signals, and the organic light emitting diodes (OLEDs) emit light having luminance (e.g., a predetermined luminance) in accordance with the supplied currents.

In FIG. 1, in the case of an exemplary embodiment of the present invention, the first power source ELVDD supplies voltages having different levels to each of the pixels 140 of the display unit 130 during one frame period, and a power source driver 170 controlling the supply of the voltage of the first power source ELVDD is further provided. The power source driver 170 is controlled by the timing controller 150.

exemplary In another embodiment of the present invention, in addition to the power source driver 170 for controlling the supply of the voltage of the first power source, a power source driver for controlling the supply of the voltage of the second power source (e.g., ELVSS) may be further included to supply the voltage having a level (e.g., a predetermined level) to be applied during one frame period.

Also, an organic light emitting diode (OLED) display according to an exemplary embodiment of the present invention is driven according to a concurrent (e.g., simultaneous) emission type (or a concurrent emission driving method).

As shown in FIG. 2, one frame period of a concurrent (e.g., simultaneous) emission type driving operation according to one embodiment of the present invention, includes a scan period in which a plurality of data signals are transmitted and programmed to all of the pixels, and a light emitting period in which all of the pixels respectively emit light according to the data signals after the data signals are programmed to all of the pixels.

In a sequential emission type driving operation, the data signals are sequentially supplied to each scan line and then the light emitting is sequentially executed (e.g., each line emits light in sequence). However, in an exemplary embodiment of the present invention, the input of the data signals is sequentially provided but the light emitting is performed for the entire display in conjunction with a completion of the input of the data signals (e.g., light is emitted in conjunction with the completion of the supply of data signals to all the pixels).

In detail, referring to FIG. 2, a driving method according to an exemplary embodiment of the present invention is divided into a reset period (a) for resetting the driving voltage of the organic light emitting diode (OLED) in the pixel, a threshold voltage compensation period (b) for compensating for the threshold voltage of the driving transistor of the OLED, a scan period (c) for transmitting the data signals to the plurality of pixels of the display unit of the OLED display, and a light emitting period (d) in which the OLED of each pixel of the display unit of the OLED display emits light corresponding to the transmitted data signal.

During the scan period (c) (e.g., the data signal input period), data signals are sequentially supplied to rows of pixels coupled to the scan lines, however, during the reset period (a), the threshold voltage compensation period (b), and the light emitting period (d) the respective operation is concurrently (or simultaneously) performed on the entire display unit 130.

According to one exemplary embodiment of the present invention, a light emitting off period (e) may be further included after the light emitting period (d).

In one embodiment, the reset period (a) is a period for resetting the driving voltage applied to the organic light emitting diode (OLED) of each pixel 140 of the display unit 130, and if the cathode of the organic light emitting diode (OLED) is fixed at a uniform voltage, the reset period is a period for setting the anode voltage of the organic light emitting diode (OLED) to 0V. In one exemplary embodiment of the present invention, to reduce or prevent a leakage current generated in the reset period (a), the voltage of the cathode of the organic light emitting diode (OLED) is set to a voltage that is higher than 0V.

Also, the threshold voltage compensation period (b) is a period for compensating for the threshold voltage of the driving transistor provided in each pixel 140.

Accordingly, the signals applied in the reset period (a), the threshold voltage compensation period (b), the light emitting period (d), and the light emitting off period (e), that is, a plurality of scan signals applied to the plurality of scan lines S1 to Sn, the voltage of the first power source ELVDD applied to a plurality of pixels 140, and a plurality of light emission control signals applied to a plurality of light emission control lines GC1 to GCn, are concurrently (e.g., simultaneously) applied to each of the pixels 140 provided in the display unit 130 at a voltage level (e.g., a predetermined voltage level).

According to the concurrent emission type according to an exemplary embodiment of the present invention, each operation period (the periods (a) to (e)) is clearly divided such that the transistors of the compensation circuit provided in each pixel 140 and the number of signal lines controlling them may be reduced.

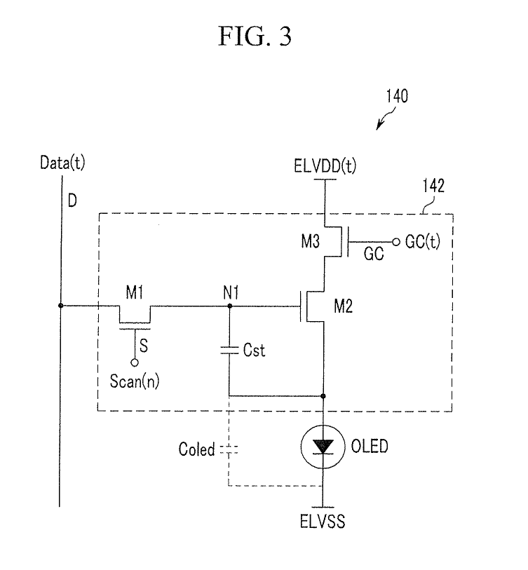

FIG. 3 is a circuit diagram showing a configuration of the pixel shown in FIG. 1 according to one exemplary embodiment of the present invention.

Referring to FIG. 3, a pixel 140 according to one exemplary embodiment of the present invention includes an organic light emitting diode (OLED), and a driving circuit 142 to supply a current to the organic light emitting diode (OLED).

An anode of the organic light emitting diode (OLED) is connected to the pixel driving circuit 142, and a cathode thereof is connected to a second power source ELVSS. This organic light emitting diode (OLED) emits light having a luminance (e.g., a predetermined luminance) corresponding to the current supplied from the pixel driving circuit 142.

The pixels 140 of the display unit 130 according to an exemplary embodiment of the present invention receive a plurality of data signals supplied to the plurality of data lines D1 to Dm during the portion of the period (the period (c)) of one frame when a plurality of scan signals are sequentially applied to the plurality of scan lines S1 to Sn. In contrast, the voltage of the first power source ELVDD applied to the plurality of pixels 140, and the plurality of light emission control signals applied to the plurality of light emission control lines GC1 to GCn are concurrently applied in conjunction with a voltage level (e.g., a predetermined voltage level) to each pixel 140 for the other periods (e.g., the periods (a), (b), (d), and (e)) of one frame.

The driving circuit 142 of the pixel provided in each pixel 140 includes a first switch M1, a driving transistor M2, a second switch M3, and a capacitor Cst.

Also, the driving circuit of each pixel according to another exemplary embodiment of the present invention may further have one terminal of the capacitor Cst coupled to the first node N1 and another terminal of the capacitor opposite to the one terminal, and a parasitic capacitor Coled which is coupled between the cathode of the organic light emitting diode (OLED) and the another terminal of the capacitor Cst.

The parasitic capacitor Coled is connected to use the coupling effect along with the capacitor Cst in consideration of the capacitance of the parasitic capacitor formed by the anode and the cathode of the organic light emitting diode (OLED).

In the embodiment shown in FIG. 3, the gate electrode of the first switch M1 is connected to the scan line S, and the first electrode thereof is connected to the data line D. The second electrode of the first switch M1 is connected to the first node N1.

The gate electrode of the first switch M1 is supplied with the scan signal Scan(n), and the first electrode is supplied with the data signal Data(t).

The gate electrode of the driving transistor M2 is connected to the first node N1, and the first electrode is connected to the anode of the organic light emitting diode (OLED). Also, the second electrode of the driving transistor M2 is connected to the first power source ELVDD(t) through the first electrode and the second electrode of the second switch M3. The driving transistor M2 functions as the driving transistor for applying the driving current to the OLED in accordance with the data signal corresponding to the OLED.

The gate electrode of the second switch M3 is connected to the light emission control line GC, the first electrode is connected to the second electrode of the driving transistor M2, and the second electrode is connected to the first power source ELVDD(t).

Accordingly, the gate electrode of the second switch M3 is supplied with the light emission control signal GC(t), and the second electrode is supplied with the voltage of the first power source ELVDD that is varied to a level (e.g., a predetermined level) and provided.

Also, the cathode of the organic light emitting diode (OLED) is connected to the second power source ELVSS, and the capacitor Cst is connected between the gate electrode of the driving transistor M2, that is, the first electrode of the first node N1 and the driving transistor M2, that is, the anode of the organic light emitting diode (OLED).

In the case of an exemplary embodiment shown in FIG. 3, all of the first switch M1, the driving transistor M2, and the second switch M3 are realized by NMOS transistors. However, the first switch M1, the driving transistor M2, and the second switch M3 are not limited thereto, and in other embodiments they may be realized by PMOS transistors.

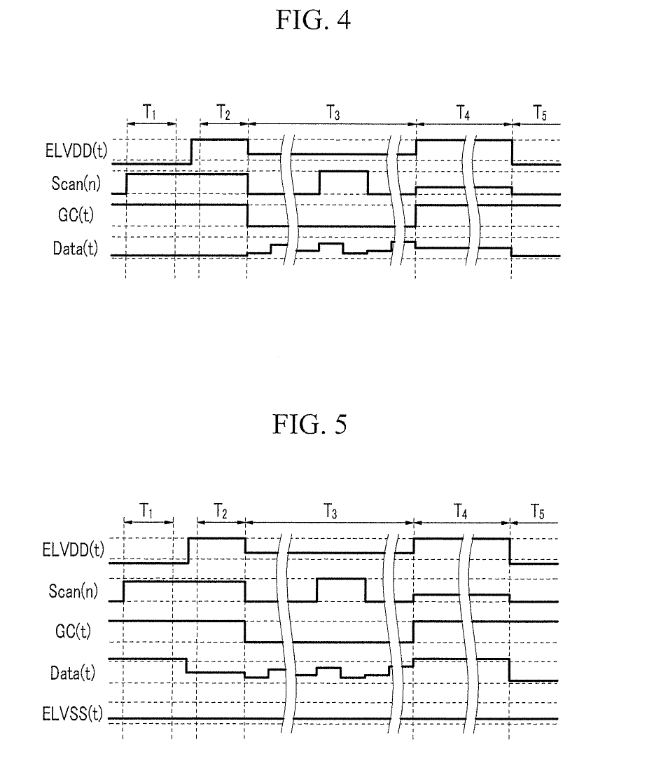

As described above, the pixel 140 of one exemplary embodiment of the present invention is driven as the concurrent (e.g., simultaneous) emission type driving operation, and in detail as shown in FIG. 4, each frame is divided into a reset period T1, a threshold voltage compensation period T2, a scan period T3, a light emitting period T4, and a light emitting off period T5. That is, one frame may be realized by including the reset period T1, the threshold voltage compensation period T2, the scan period T3, the light emitting period T4, and the light emitting off period T5.

In one embodiment, a plurality of scan signals are sequentially supplied to the scan lines and the plurality of data signals are sequentially supplied to each pixel for the scan/data input periods T3, however the signals having voltages (e.g., the voltage having predetermined levels), that is, the voltages of the first power source ELVDD(t), the scan signal Scan(n), the light emission control signal GC(t), and the data signal Data(t), are applied in conjunction (or concurrently) to all pixels 140 forming the display unit during the other periods (e.g., T1, T2, T4, and T5).

That is, the anode voltage reset of the organic light emitting diode (OLED), the threshold voltage compensation of the driving transistor M2 of each pixel 140, and the light emitting operation of each pixel are concurrently realized in all pixels 140 of the display unit during a frame.

Particularly, as shown in FIG. 4, for the driving timing of the pixel of the organic light emitting diode (OLED) display of the concurrent emission type, the voltage value of the data signal voltage is maintained at a substantially constant level (e.g., a predetermined level) during the reset period T1, the threshold voltage compensation period T2, the light emitting period T4, and the light emitting off period T5, but not during the scan period T3.

Particularly, the voltage of the data signal maintains the low voltage of a level (e.g., a predetermined level) during the reset period T1 and the threshold voltage compensation period T2, and does not maintain the level (e.g., the predetermined voltage value) during the light emitting period T4. Accordingly, in general, the voltage of the data signal of the final scan line is applied during the light emitting period T4.

However, according to the pixel driving timing diagram of the concurrent (e.g., simultaneous) emission type, if the voltage of the data signal has a low voltage during the reset period T1 and the threshold voltage compensation period T2, it is difficult for the driving transistor of the organic light emitting diode (OLED) to be turned on such that it may be difficult for the anode voltage of the organic light emitting diode (OLED) to be reset. In contrast, if the voltage of the data signal has a high voltage during the reset period T1 and the threshold voltage compensation period T2, it may be difficult to compensate for the threshold voltage of the driving transistor.

Also, as shown in FIG. 4, when the voltage of the data signal in the light emitting period T4 is not specially designated and is supplied at the data signal voltage of the final scan line, if the voltage is set at a low voltage, the leakage current is generated toward the first switch of the pixel during light emission such that the image quality may be seriously deteriorated.

Accordingly, in one embodiment of the present invention, for the reset of the driving voltage and the compensation of the threshold voltage of the driving transistor of the organic light emitting diode (OLED) to be performed efficiently and concurrently, the voltage of the data signal is controlled for the period in the concurrent emission type of the organic light emitting diode (OLED) display to reduce the leakage current of the first switch during the light emitting period of the organic light emitting diode (OLED).

To obtain this objective, the driving timing diagram showing the driving of the pixel of the concurrent emission type of the organic light emitting diode (OLED) display according to an exemplary embodiment of the present invention is shown in FIG. 5. Also, as shown in FIG. 5, the voltage value of the second power source ELVSS connected to the cathode of the organic light emitting diode (OLED) is set at a level (e.g., a predetermined level) and applied such that the leakage current toward the organic light emitting diode (OLED) is limited and reduced or minimized during the reset of the anode of the organic light emitting diode (OLED).

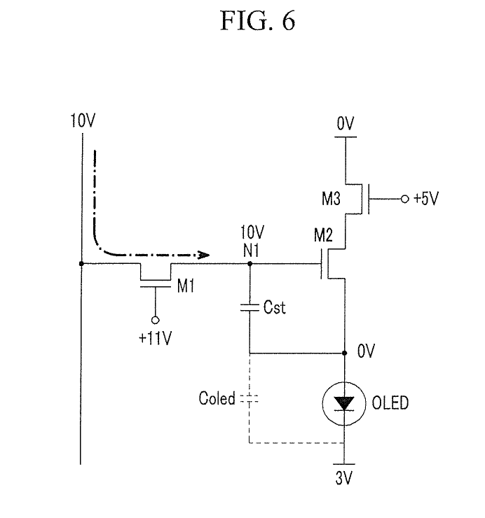

Next, the driving of the concurrent emission type of organic light emitting diode (OLED) display according to an exemplary embodiment of the present invention will be described with reference to FIG. 6 through FIG. 15.

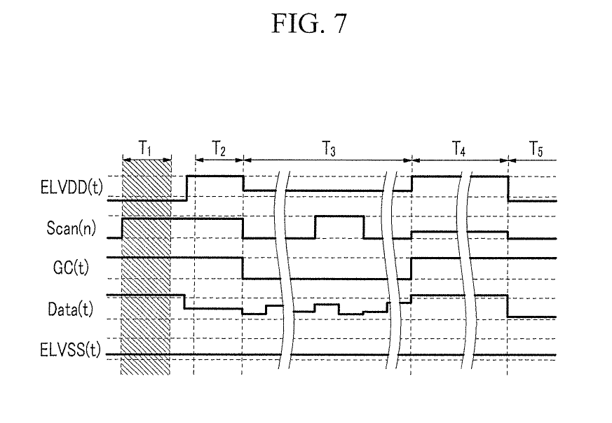

FIGS. 6, 8, 10, 12, and 14 are circuit diagrams showing pixel driving for each driving period of a method of driving an organic light emitting diode (OLED) display according to an exemplary embodiment of the present invention, and FIGS. 7, 9, 11, 13, and 15 are driving timing diagrams showing pixel driving for driving periods of a method of driving an organic light emitting diode (OLED) display according to an exemplary embodiment of the present invention.

In the embodiments shown in FIGS. 6 through 15, for ease of description, the voltage levels of the signals are given particular values. These voltage levels are arbitrary values chosen for enhancement of understanding and embodiments of the present invention are not limited to the voltages recited herein.

Firstly, referring to FIG. 6 and FIG. 7, the reset period among the periods realizing one frame is shown according to one embodiment. The period in which the data voltage applied to each pixel 140 of the display unit 130 is reset is the period in which the voltage of the anode of the organic light emitting diode (OLED) is decreased below the voltage of the cathode so that the light emitting diode (OLED) does not emit light.

In an exemplary embodiment of the present invention, the voltage of the first power source ELVDD(t) is applied at a low level (for example 0V) during the reset period, the scan signal Scan(n) is applied at a high level (for example 11V), and the light emission control signal GC(t) is applied at a high level (for example 5V).

As described above, when the data signal having a high level is applied to the gate electrode of the driving transistor, the current that may flow in the driving transistor is greater than when the data signal having a low level shown in FIG. 4 is applied to the gate electrode. Accordingly, the charges accumulated to the anode of the organic light emitting diode (OLED) are quickly discharged by the 0V voltage. Thus, the driving voltage of the organic light emitting diode (OLED) may be quickly reset.

In detail, if the first node N1 is supplied with 10V as the data signal, that is, a voltage level capable of turning the driving transistor M2 on, a current path is formed from the anode of the organic light emitting diode (OLED) to the first power source ELVDD(t) through the turned-on driving transistor M2 and the second switch M3. Accordingly, the anode voltage of the organic light emitting diode (OLED) is decreased to the voltage value of the first power source ELVDD(t) as 0V.

The voltage value of the high level is not specially limited, and it may be determined (or set) as the highest voltage value of the voltage range of the data signal. As described above, if the voltage of the data signal is applied at a high level during the reset period, the gate electrode of the driving transistor is applied at a voltage that is sufficient to turn on the driving transistor, and accordingly, the anode voltage of the organic light emitting diode (OLED) is quickly reset to 0V.

Accordingly, in an exemplary embodiment of the present invention, the voltage of the second power source ELVSS connected to the cathode of the organic light emitting diode (OLED) is applied as the voltage of a low level (e.g., a predetermined appropriate low level), that is, a low level voltage having a voltage level (e.g., a predetermined level) such that the leakage current supplied to the organic light emitting diode (OLED) is limited.

Referring to FIGS. 6 and 7, the first switch M1, driving transistor M2, and the second switch M3 are turned on according to the application of the signal during the reset period.

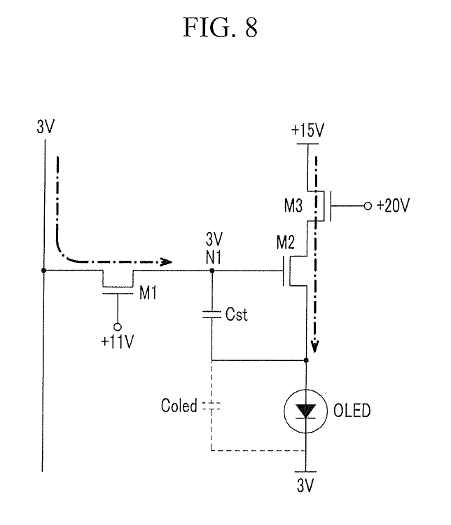

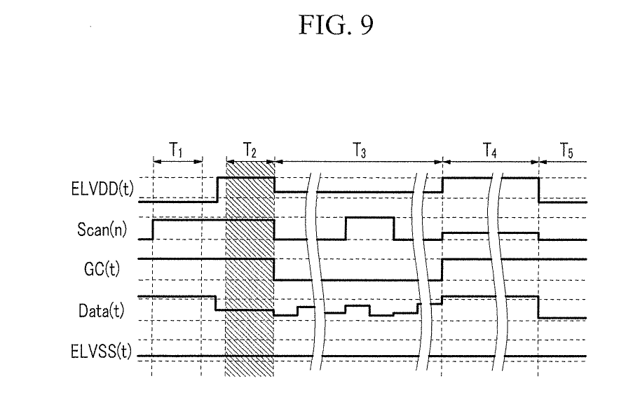

Next, referring to FIG. 8 and FIG. 9, the threshold voltage compensation period of the driving transistor among the periods realizing one frame according to one embodiment is described. That is, this is the period in which the threshold voltage of the driving transistor M2 provided in each pixel 140 of the display unit 130 is stored to (or in) the capacitor Cst, and this period has the function of reducing or removing the deterioration in image quality due to the threshold voltage variation of the driving transistor when the data voltage is later charged to each pixel.

According to an exemplary embodiment of the present invention, during the threshold voltage compensation period, the voltage of the first power source ELVDD(t) is applied at a high level (for example 15V), the scan signal Scan(n) and the light emission control signal GC(t) are respectively applied at a high levels (for example 11V and 20V), and the data signal Data(t) is applied at a voltage value that is less than the previous reset period, but is applied at a relatively high level (for example 3V).

According to exemplary embodiments of the present invention, the voltage of the data signal during the threshold voltage compensation period is not limited to the voltages indicated in the embodiments described above. Other voltage values that are capable of representing the threshold voltage deviation of the driving transistor when the data voltage is charged to (or stored in) each pixel may be applied.

In an embodiment of the present invention, when comparing the voltage of the data signal during the reset period and the voltage of the data signal during the threshold voltage compensation period of the driving transistor, the voltage of the data signal during the threshold voltage compensation period is equal to the data signal voltage of the reset period, or, in another embodiment, is less than the data signal voltage of the reset period.

The voltage of the data signal during the threshold voltage compensation period may be set as the lowest voltage value sufficient to turn on the driving transistor.

In one embodiment, the threshold voltage compensation is performed concurrently for each pixel forming the display unit such that the signals applied in the threshold voltage compensation period, that is, the voltage of the first power source ELVDD(t), the scan signal Scan(n), the light emission control signal GC(t), and the data signal Data(t) are concurrently applied at a voltage value having a level (e.g., a predetermined level) to all pixels. The first switch M1, the driving transistor M2, and the second switch M3 are turned on in accordance with the application of the above-described signals.

In detail, in one embodiment of the present invention during the previous reset period, the anode voltage of the organic light emitting diode (OLED) is 0V, the gate electrode voltage of the driving transistor during the threshold voltage compensation period is 3V, and the voltage of the first power source is 15V. Here, for the purpose of illustration, the threshold voltage of the driving transistor is assumed to be 1V, however in other embodiments of the present invention, the threshold voltage of the driving transistor may have a different value.

As described above, in one embodiment of the present invention, the gate electrode voltage is 3V, and the anode voltage, that is, the source electrode voltage of the driving transistor, is 0V such that the driving transistor is turned on. Thus, the source electrode voltage is the threshold voltage subtracted from the gate electrode voltage (e.g., 2V). The voltage of the cathode of the organic light emitting diode (OLED) is at 3V such that the current does not flow to the organic light emitting diode (OLED).

Therefore, during the threshold voltage compensation period T2, the capacitor Cst is charged with a voltage corresponding to the threshold voltage of the driving transistor.

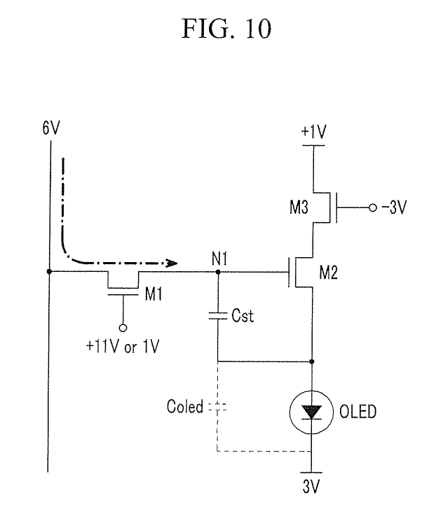

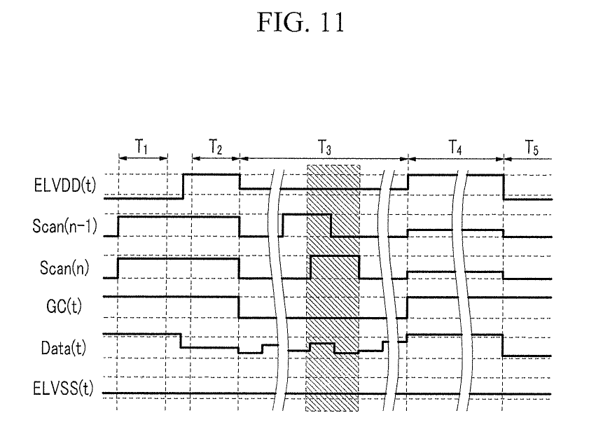

Next, referring to FIG. 10 and FIG. 11, the scan period/data input periods among the periods of one frame according to one embodiment are described. That is, this is the period in which the scan signals are sequentially applied to the plurality of scan lines S1 to Sn connected to respective pixels of the display unit 130, and the data signals are supplied to the plurality of data lines D1 to Dm.

That is, driving the scan period/data input period shown in FIG. 11, the scan signals are sequentially supplied to each scan line, the data signals are sequentially supplied to the rows of pixels connected to the scan lines, and the light emission control signal GC(t) is applied at a low level (for example −3V) during the above-described period.

In one exemplary embodiment of the present invention, as shown in FIG. 11, the scan signal that is sequentially applied has a width of two horizontal periods 2H. That is, the width of the (n−1)th scan signal Scan(n−1) and the width of the n-th scan signal Scan(n) that are applied sequentially overlap by one horizontal period 1H.

This is to account for an insufficient charging phenomenon according to RC delay of the signal lines due to the large area of the display unit.

Also, in one embodiment the second switch M3, which is an NMOS device, is turned off by the light emission control signal GC(t) applied at a low level, and thereby the voltage of the first power source ELVDD(t) may not affect the pixel during the scan period/data input period.

In the case of a pixel of the organic light emitting diode (OLED) display according to an embodiment of the present invention shown in the circuit diagram of FIG. 10, if a scan signal having a high level is applied such that the first switch M1 is turned on, a data signal having a voltage (e.g., a predetermined voltage value) is applied to the first node N1 while passing through the first electrode and the second electrode of the first switch.

In the embodiments shown in FIG. 10, it is assumed that the voltage value of the applied data signal is 6V, the voltage of the first node N1 is increased to 6V from 3V of the previous period, and the voltages of both terminals of the capacitor are changed according to the change of the data signal voltage. The voltage of both terminals of the capacitor in the threshold voltage compensation period are changed so that the voltage corresponding to the threshold voltage of the driving transistor is maintained across the capacitor. Also, if the voltage of one terminal of the capacitor during the scan period, that is, the voltage of the gate electrode of the driving transistor, is changed to the voltage of the data signal, the voltage of the another terminal of the capacitor is changed by the voltage corresponding to the changing of (or change in) the data signal from the voltage charged during the threshold voltage compensation period.

In more detail, the voltage of the second terminal of the capacitor is changed due to the coupling effect of the capacitor according to the changing of the data signal voltage. Here, the voltage of the second terminal of the capacitor Cst changes according to the capacitance ratio between the parasitic capacitor Coled and the capacitor Cst that are connected to the organic light emitting diode (OLED).

During the scan period, the second switch M3 is turned off such that a current path is not formed between the organic light emitting diode (OLED) and the first power source ELVDD and therefore current does not substantially flow to the organic light emitting diode (OLED). That is, in one embodiment of the present invention, light is not emitted during the scan period.

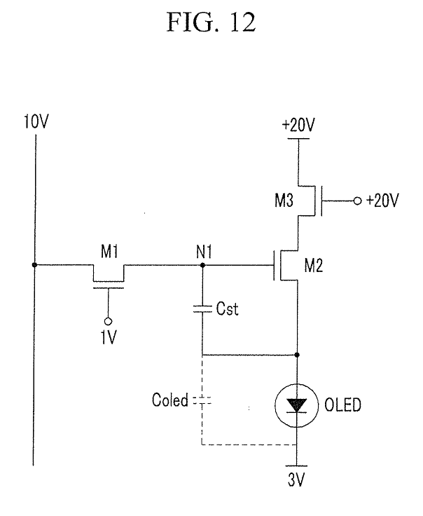

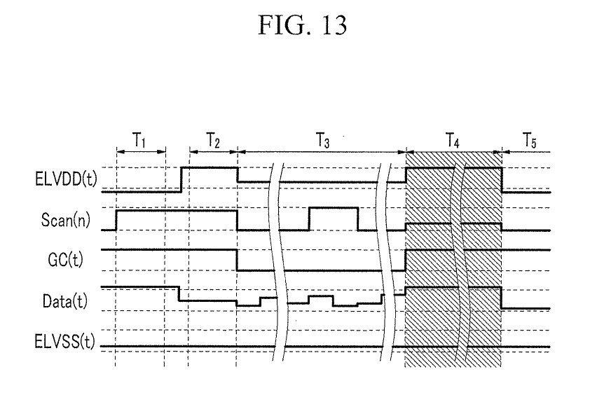

Next, referring to FIG. 12 and FIG. 13, the light emitting period among the periods that constitute one frame in which the organic light emitting diode (OLED) of the pixel emits light corresponding to the data signal supplied during the scan period is described according to one embodiment of the present invention. That is, this is the period in which a current corresponding to the data signal voltage stored in each pixel 140 of the display unit 130 is provided to the organic light emitting diode (OLED) of each pixel 140 such that light is emitted.

That is, in one embodiment of the present invention, the voltage of the first power source ELVDD(t) is applied at a high level (for example 20V) in the light emitting period, the scan signal Scan(n) is applied at a low level (for example 1V), and the light emission control signal GC(t) is applied at a high level (for example 20V). According to the above embodiment of the present invention, the low level of the scan signal Scan(n) is set at 1V, however in other embodiments of the present invention other voltages may be supplied, such as a negative voltage of a degree capable of turning off the first switch M1.

Here, the scan signal Scan(n) is applied at a low level such that the first switch M1 of the NMOS is turned off, and here, the voltage of the data signal of the organic light emitting diode (OLED) display according to an exemplary embodiment of the present invention is at a high level (for example 10V) such that the leakage current does not flow into (or through) the first switch.

The voltage of the data signal during the light emitting period in which the organic light emitting diode (OLED) emits light is not limited to the voltages of the above embodiments, however, in one embodiment, it is a voltage that does not generate the leakage current (or generates substantially no leakage current) to the first switch transmitting the corresponding data signal to the driving transistor. In one embodiment, the voltage is the highest voltage value of the data signal among the voltage values of the corresponding data signal according to the plurality of scan signals during the scan period.

Also, during the light emitting period, light emission is performed concurrently for each pixel in the display unit, and thereby the signals applied during the light emitting period, that is, the voltage of the first power source ELVDD(t), the scan signal Scan(n), the light emission control signal GC(t), and the data signal Data(t) are concurrently applied to all pixels with voltage values having levels (e.g., predetermined levels).

According to the application of the above-descried signals, in one embodiment of the present invention, the driving transistor M2, and the second switch M3 are turned on and the first switch M1 is turned off during the light emitting period.

A current path is formed between the first power source ELVDD and the cathode of the organic light emitting diode (OLED) by the turn-on of the driving transistor M2 and the second switch M3, and a current corresponding to the voltage value Vgs of the driving transistor M2, that is, the current corresponding to the voltage difference between the gate electrode and the first electrode of the driving transistor, is applied to the organic light emitting diode (OLED), thereby emitting light with luminance corresponding thereto.

According to an exemplary embodiment of the present invention, the voltage of the data signal is applied at a high level such that the generation of the leakage current toward the first switch is reduced or minimized, and thereby a high quality display with improved luminance using light emission of the organic light emitting diode (OLED) may be realized.

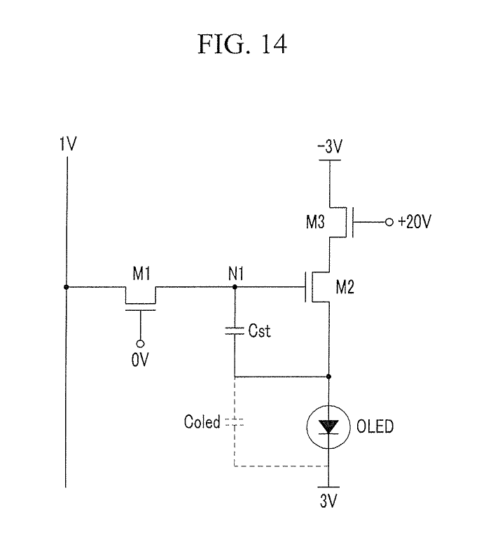

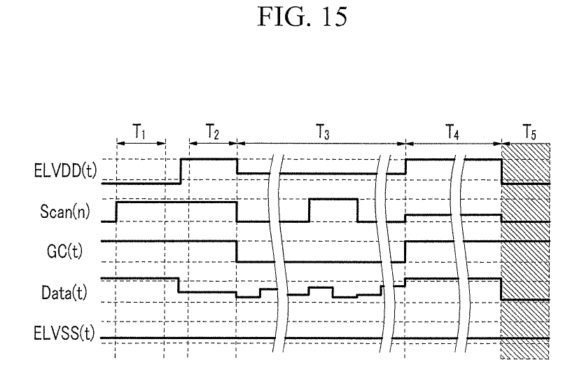

As described above, after the light emitting period in which the whole display unit emits light, according to another exemplary embodiment of the present invention, as shown in FIG. 14 and FIG. 15, the light emitting off period may be executed.

That is, referring to FIG. 14, in one embodiment of the present invention, during a light emitting off period, the voltage of the first power source ELVDD(t) is applied at a low level (for example −3V), the scan signal Scan(n) is applied at a low level (for example 1V or 0V), the light emission control signal GC(t) is applied at a high level (for example 20V), and the data signal Data(t) is applied at a low level (for example 1V) in the light emitting off period.

That is, comparing the light emitting off period with the light emitting period of FIG. 12, this period is similar to the light emitting period except that the voltage of the first power source ELVDD(t) is changed from a high level to a low level (for example −3V) and the data signal Data(t) is changed from a high level to a low level (for example 1V).

In this case, a current path is formed between the first power source ELVDD and the OLED by the turn-on of the driving transistor and the second switch M3 such that the voltage value of the anode of the organic light emitting diode (OLED) is decreased to the voltage value of the first power source ELVDD(t) (e.g., −3V), and resultantly the voltage of the anode is decreased below the voltage of the cathode such that the light emission is stopped (e.g., the OLED is turned off).

As described above in FIG. 6 to FIG. 15, according to one embodiment of the present invention, one frame includes the reset period, the threshold voltage compensation period, the scan period, the light emitting period, and the light emitting off period, and these periods are repeated, thereby forming the next frame. That is, the reset period of FIG. 6 and FIG. 7 is again executed after the light emitting off period of FIG. 14 and FIG. 15.

Although the present invention is described with reference to the detailed exemplary embodiments of the present invention, this is by way of example only and the present invention is not limited thereto. A person of ordinary skill in the art may change or modify the described exemplary embodiments without departing from the scope of the present invention, and the changes or modifications are also included in the scope of the present invention. Further, materials of each components described in the present specification are easily selected or replaced from various materials known to a person of ordinary skill in the art. In addition, a person of ordinary skill in the art may omit some of the components described in the present specification without deteriorating the performance or may add components in order to improve the performance. Further, a person of ordinary skill in the art may change the sequence of processes described in the present specification according to the process environments or equipment. Therefore, the scope of the present invention should be defined by the appended claims and equivalents, not by the described exemplary embodiments.

Description of Symbols

| | |
|---|---|
| 110: scan driver | 120: data driver |
| 130: display unit | 140: pixel |
| 142: pixel driving circuit | 150: timing controller |
| 160: light emission driver | 170: first power source driver |

What is claimed is:

1. An organic light emitting diode (OLED) display comprising:
a display unit comprising:
a plurality of scan lines;
a plurality of light emission control lines;
a plurality of data lines; and
a plurality of pixels, each of the plurality of pixels being coupled to a corresponding scan line among the plurality of scan lines, a corresponding light emission control line among the plurality of light emission control lines, and a corresponding data line among the plurality of data lines;
a scan driver configured to transmit a plurality of scan signals to the plurality of scan lines;
a light emission driver configured to transmit a plurality of light emission control signals to the plurality of light emission control lines;
a data driver configured to transmit a plurality of data signals to the plurality of data lines; and
a power source driver configured to apply a plurality of power source voltages having different levels to the plurality of pixels during one frame period,
wherein each of the plurality of pixels comprises an OLED and a driving transistor configured to transmit a current to the OLED in accordance with a corresponding data signal of the data signals, and
wherein during a reset period, a plurality of voltages of the plurality of data signals for resetting a driving voltage of the OLED has a higher voltage than corresponding voltages of the plurality of data signals during a threshold voltage compensation period for compensating for the threshold voltage of the driving transistor.

2. The OLED display of claim 1, wherein
during the reset period, each of the plurality of data signals has a voltage higher than a highest voltage of a voltage range of the plurality of data signals during a scan period.

3. The OLED display of claim 1, wherein during the threshold voltage compensation period, each of the plurality of data signals has a voltage signal equal to a lowest voltage sufficient to turn on the driving transistor.

4. The OLED display of claim 1, wherein
each of the plurality of pixels further comprises a first switch configured to transmit the corresponding data signal to the driving transistor in accordance with a corresponding scan signal among the plurality of scan signals, and
the scan driver is configured to concurrently transmit the plurality of scan signals to the plurality of scan lines during the reset period and the threshold voltage compensation period.

5. The OLED display of claim 4, wherein
each of the plurality of pixels further comprises a second switch configured to transmit a first power source voltage to the driving transistor in accordance with a light emission control signal of the light emission control signals,
the driving transistor is coupled to an anode of the OLED,
the second switch is configured to be turned on during the reset period, and
during the reset period the first power source voltage is lower than the voltage of a cathode of the OLED.

6. The OLED display of claim 1, wherein
the scan driver is configured to sequentially transmit the plurality of scan signals to the plurality of scan lines during a scan period after the reset period and the threshold voltage compensation period, and
the data driver is configured to transmit the plurality of data signals to the plurality of data lines in synchronization with the transmission of the plurality of scan signals to the scan lines.

7. The OLED display of claim 1, wherein the data driver is configured to transmit, during a light emitting period, the plurality of data signals to corresponding ones of the plurality of pixels such that substantially no leakage current is generated in a first switch of each pixel configured to transmit the corresponding data signal to the driving transistor.

8. The OLED display of claim 7, wherein the first switch is configured to transmit the corresponding data signal to the driving transistor in accordance with a corresponding scan signal of the plurality of scan signals, and
the scan driver is configured to concurrently transmit the plurality of scan signals to the plurality of scan lines during the light emitting period.

9. The OLED display of claim 7, wherein during the light emitting period, each of the data signals has a voltage higher than a highest voltage of a voltage range of the data signal during a scan period.

10. The OLED display of claim 7, wherein
the scan driver is configured to sequentially transmit the plurality of scan signals to the plurality of scan lines during a scan period before the light emitting period and after the reset period and the threshold voltage compensation period, and
the data driver is configured to transmit the plurality of data signals to the plurality of data lines in synchronization with the transmission of the plurality of scan signals to the scan lines.

11. An organic light emitting diode (OLED) display comprising:
a display unit comprising:
a plurality of scan lines;
a plurality of light emission control lines;
a plurality of data lines; and
a plurality of pixels, each of the plurality of pixels being coupled to a corresponding scan line among the plurality of scan lines, a corresponding light emission control line among the plurality of light emission control lines, and a corresponding data line among the plurality of data lines;
a scan driver configured to transmit a plurality of scan signals to the plurality of scan lines;
a light emission driver configured to transmit a plurality of light emission control signals to the plurality of light emission control lines;
a data driver configured to transmit a plurality of data signals to the plurality of data lines; and
a power source driver configured to apply a plurality of power source voltages having different levels to the plurality of pixels during one frame period,
wherein each of the plurality of pixels comprises an OLED, a driving transistor configured to transmit a current to the OLED in accordance with a corresponding data signal of the data signals and a first switch configured to transmit the corresponding data signal to the driving transistor, and
wherein the data driver is configured to supply, during a light emitting period, the plurality of data signals to the plurality of pixels, the plurality of data signals having voltages which generate substantially no leakage current in the first switch.

12. The OLED display of claim 11, wherein
the first switch is configured to transmit the corresponding data signal to the driving transistor in accordance with a corresponding scan signal of the plurality of scan signals, and
the scan driver is configured to concurrently transmit the plurality of scan signals to the plurality of scan lines during the light emitting period.

13. The OLED display of claim 11, wherein during the light emitting period each of the data signals has a voltage higher than a highest voltage of a voltage range of the data signals during a scan period such that substantially no leakage current is generated in the first switch.

14. The OLED display of claim 11, wherein
the scan driver is configured to sequentially transmit the plurality of scan signals to the plurality of scan lines during a scan period before the light emitting period in which the plurality of scan signals are transmitted to the plurality of scan lines, and
the data driver is configured to transmit the plurality of data signals to the plurality of data lines in synchronization with the transmission of the plurality of scan signals to the scan lines.

15. An organic light emitting diode (OLED) display comprising:
an OLED;
a driving transistor configured to transmit a driving current in accordance with a data signal of a plurality of data signals to the OLED; and
a first switch configured to transmit the data signal to a gate terminal of the driving transistor in accordance with a scan signal,
wherein during a reset period a voltage of the data signal for resetting a driving voltage of the OLED is higher than a voltage of the data signal during a threshold voltage compensation period for compensating for the threshold voltage of the driving transistor.

16. The OLED display of claim 15, wherein
during the reset period, the data signal has a voltage higher than a highest voltage of a voltage range of the plurality of data signals during a scan period.

17. The OLED display of claim 15, wherein during the threshold voltage compensation period, the data signal has a voltage equal to a lowest voltage that is sufficient to turn on the driving transistor.

18. The OLED display of claim 15, further comprising
a second switch configured to transmit a first power source voltage to the driving transistor in accordance with a light emission control signal,
wherein the driving transistor is connected to an anode of the OLED,
wherein the second switch is configured to be turned on during the reset period, and
wherein the first power source voltage has a voltage lower than a voltage of a cathode of the OLED during the reset period.

19. The OLED display of claim 15, wherein
the first switch is configured to receive the scan signal during a scan period after the reset period and the threshold voltage compensation period, and
the gate terminal of the driving transistor is configured to receive the data signal in synchronization with the scan signal received by the first switch.

20. The OLED display of claim 15, wherein
during a light emitting period, the data signal has a voltage such that substantially no leakage current is generated in the first switch.

21. The OLED display of claim 20, wherein
the voltage such that substantially no leakage current is generated in the first switch is higher than a highest voltage of a voltage range of the data signal during a scan period.

22. The OLED display of claim 20, wherein
the first switch is configured to receive the scan signal during a scan period before the light emitting period and after the reset period and the threshold voltage compensation period, and the gate terminal of the driving transistor is configured to receive the data signal in synchronization with the scan signal.

23. An organic light emitting diode (OLED) display comprising:
an OLED;
a driving transistor configured to transmit a driving current in accordance with a data signal to the OLED; and
a first switch configured to transmit the data signal to a gate terminal of the driving transistor in accordance with a scan signal,
wherein, during a light emitting period, the data signal has a voltage such that substantially no leakage current is generated in the first switch.

24. The OLED display of claim 23, wherein
the voltage such that substantially no leakage current is generated in the first switch is higher than a highest voltage of a voltage range of the data signal during a scan period.

25. The OLED display of claim 23, wherein
the first switch is configured to receive the scan signal during a scan period before the light emitting period, and the gate terminal of the driving transistor is configured to receive the data signal corresponding to the scan signal in synchronization with the scan signal.

26. A driving method of an organic light emitting diode (OLED) display comprising a plurality of pixels, wherein each of the plurality of pixels comprises an OLED and a driving transistor configured to transmit a driving current in accordance with a data signal to the OLED, comprising:
resetting a driving voltage of the OLED during a reset period;
compensating for a threshold voltage of the driving transistor during a threshold voltage compensation period; and
transmitting the data signal to the driving transistor during a scan period,
wherein a voltage of the data signal during the reset period is higher than a voltage of the data signal during the threshold voltage compensation period.

27. The driving method of claim 26, wherein
the data signal corresponding to the reset period has a voltage higher than a highest voltage of a voltage range of the data signal during the scan period.

28. The driving method of claim 26, wherein
the voltage of the data signal corresponding to the threshold voltage compensation period is equal to a lowest voltage that is sufficient to turn on the driving transistor.

29. The driving method of claim 26, wherein
each of the plurality of pixels further comprises a first switch configured to transmit the data signal to the driving transistor in accordance with a scan signal, and
a scan driver is configured to transmit the scan signal to the plurality of pixels during the reset period and the threshold voltage compensation period.

30. The driving method of claim 29, wherein
each of the plurality of pixels further comprises a second switch configured to transmit a first power source voltage to the driving transistor in accordance with a light emission control signal,
the driving transistor is coupled to an anode of the OLED,
the second switch is turned-on during the reset period, and
the first power source voltage has a voltage lower than the voltage of a cathode of the OLED during the reset period.

31. The driving method of claim 26, wherein
during the scan period, a plurality of scan signals are sequentially transmitted to the plurality of pixels, and the data signal is transmitted in synchronization with the transmission of a corresponding scan signal of the scan signals.

32. The driving method of claim 26, further comprising
transmitting the data signal to the plurality of pixels such that each OLED of the plurality of pixels emits light during a light emitting period after the scan period,
wherein during the light emitting period, the data signal has a voltage such that substantially no leakage current is generated in a first switch configured to transmit the data signal to the driving transistor.

33. The driving method of claim 32, further comprising:
transmitting the data signal to the driving transistor in accordance with the corresponding scan signal of a plurality of scan signals; and
concurrently transmitting the plurality of scan signals during the light emitting period.

34. The driving method of claim 32, wherein
the voltage such that substantially no leakage current is generated in the first switch is higher than a highest voltage of a voltage range of the data signal during the scan period.

35. The driving method of claim 32, wherein
during the scan period before the light emitting period, a scan signal is sequentially transmitted to the plurality of pixels, and the data signal corresponding to the scan signal is transmitted in synchronization with the transmission of the scan signal.

36. A driving method of an organic light emitting diode (OLED) display comprising a plurality of pixels, wherein each of the plurality of pixels comprises an OLED, a driving transistor configured to transmit a driving current in accordance with a data signal to the OLED, and a first switch configured to transmit the data signal to the driving transistor in accordance with a scan signal, comprising:
transmitting the data signal to the driving transistor during a scan period; and
emitting light from the OLED in accordance with the driving current during a light emitting period,
wherein, during the light emitting period, the data signal has a voltage such that substantially no leakage current is generated in the first switch.

37. The driving method of claim 36, wherein
a scan driver is configured to concurrently transmit the scan signal to the plurality of pixels during the light emitting period.

38. The driving method of claim 36, wherein
the voltage such that substantially no leakage current is generated in the first switch is higher than a highest voltage of a voltage range of the data signal.

39. The driving method of claim 36, wherein
during the scan period before the light emitting period, the scan signal is sequentially transmitted to the plurality of pixels, and the data signal corresponding to the scan signal is transmitted in synchronization with the transmission of the scan signal.

40. The driving method of claim 36, further comprising:
resetting the driving voltage of the OLED during a reset period; and
compensating for a threshold voltage of the driving transistor during a threshold voltage compensation period before the scan period and the light emitting period,
wherein the voltage of the data signal during the reset period and the voltage of the data signal during the light emitting period are higher than the voltage of the data signal during the threshold voltage compensation period.

41. The driving method of claim 40, wherein
the voltage of the data signal during the reset period and the voltage of the data signal during the light emitting period are higher than a highest voltage of a voltage range of the data signal transmitted to the driving transistor during the scan period.

42. The driving method of claim 40, wherein during the threshold voltage compensation period, the data signal has a voltage equal to a lowest voltage that is sufficient to turn on the driving transistor.
